(19) United States
(12) Patent Application Publication
(10) Pub. No.: US 2015/0306899 A1
(43) Pub. Date: Oct. 29, 2015

(54) STYLUS PEN

(71) Applicant: Pao Feng Li, NEW TAIPEI CITY (TW)

(72) Inventor: Pao Feng Li, NEW TAIPEI CITY (TW)

(21) Appl. No.: 14/261,408

(22) Filed: Apr. 24, 2014

(51) Int. Cl. B43K 29/00; B43K 25/02; G06F 3/0354; B43K 24/08

(52) U.S. Cl. CPC B43K 29/00; B43K 24/08; B43K 25/02; G06F 3/03545

(57) ABSTRACT

The present invention is provided with a stylus pen combined with a writing function which is characterized in that a stylus pen is characterized in that a stylus pen comprises a barrel which made of a non-mental material; an ink device arranged inside the barrel; a thrust device arranged at top of the barrel; a tip disposed at the bottom of the barrel; and a touching head disposed on the tip and provided with an orifice for the ink device therethrough, both the non-metal barrel and the tip are coated with a layer of electroplate in the surface for electric conduction so as to conduct the electric to a touch screen of electronic product through the touching head by transmission from an operator's static electric current.

### FIELD OF THE INVENTION

The present invention relates to a stylus pen, particularly to a pen for the capacitive touch screen, simultaneously, for writing on paper.

### BACKGROUND OF THE INVENTION

The touch screen cellphones and computers have become popular in recent years, people like to use their fingers to slide on the touch screen for turning the pages or clicking on apps, but sometimes it is hard to click precisely on smaller touch screen due to the fact that someone have bigger fingers or longer nails. Therefore, the stylus pen can solve this kind of problem, but most of this kind of pen's barrels are made from metal material and only for single function of touch screen, the disadvantages of prior art are inconvenience for people who need to bring many different function pens at the same time, higher manufacturing costs and the use of heavier pen barrel. The technical problem to be solved by the utility model is to overcome defects of the prior art and develop a lighter, multifunction, and lower cost of stylus pen.

### SUMMARY OF INVENTION

The present invention is provided with a stylus pen combined with a writing function.

In order to solve the above problems, the technical scheme of the present invention is characterized in that a stylus pen is characterized in that: a stylus pen comprises a barrel which made of a non-mental material; an ink device arranged inside the barrel; a thrust device arranged at top of the barrel; a tip disposed at the bottom of the barrel; and a touching head disposed on the tip and provided with an orifice for the ink device therethrough, both the non-metal barrel and the tip are coated with a layer of electroplate in the surface for electric conduction so as to conduct the electric to a touch screen of electronic product through the touching head by transmission from an operator's static electric current.

More preferably, said barrel is further provided with a clip arranged in the outside wall of the barrel.

More preferably, said ink device comprises an ink chamber with two salient points; a spring adjoined to the salient points therebelow for the ink chamber an upward resilient force; and a retaining piece adjoined to the spring therebelow.

More preferably, said thrust device comprises a thrust tube arranged inside the barrel (1) and connected with the top of the ink chamber; and a button disposed at the top of the thrust tube.

More preferably, said button is further provided with a doll which has a plug therebelow and an aperture for the plug inserted therein.

More preferably, said touching head is a conductive rubber.

According to above technical scheme, the advantage of the present invention is both the non-metal barrel and the tip are coated with a layer of electroplate in the surface for electric conduction so as to conduct the electric to a touch screen of electronic product through the touching head by transmission from an operator's static electric current. Therefore, the operator can grip the stylus pen getting even lighter by non-mental material of pen barrel and more convenient with multifunction of writing, and lower the manufacture costs.

### BRIEF DESCRIPTION OF THE DRAWINGS

FIG. 1 is a schematic view of stylus pen of the present invention.

FIG. 2 is an exploded view of stylus pen of the present invention.

FIG. 3 and FIG. 4 are schematic cross-sectional view of stylus pen of the present invention.

FIG. 5 is an enlarged schematic view of the part A of the FIG. 4

FIG. 6 is an enlarged schematic view of the part B of the FIG. 4

FIG. 7 and FIG. 8 show a preferred embodiment of the present invention.

FIG. 9 shows a doll plugged into the stylus pen of the present invention.

### DETAILED DESCRIPTION OF THE PREFERRED EMBODIMENTS

The present invention will now be described by referring to the accompanying drawings that illustrate the preferred embodiments of the invention, from which its objects and features will be evident:

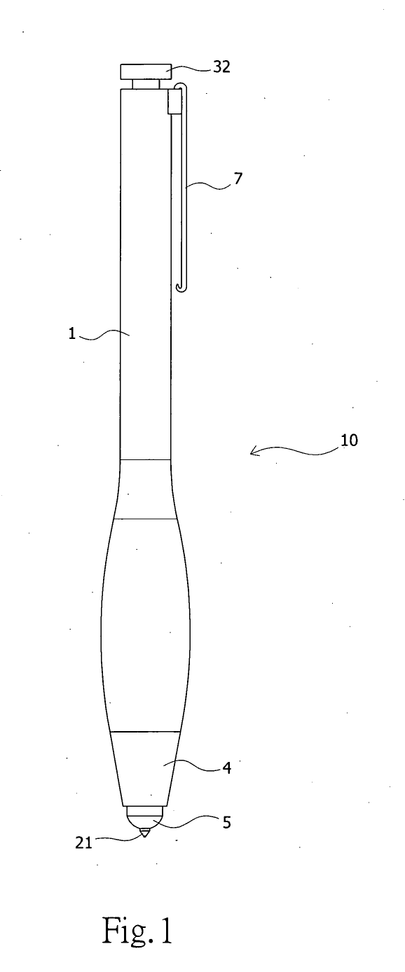

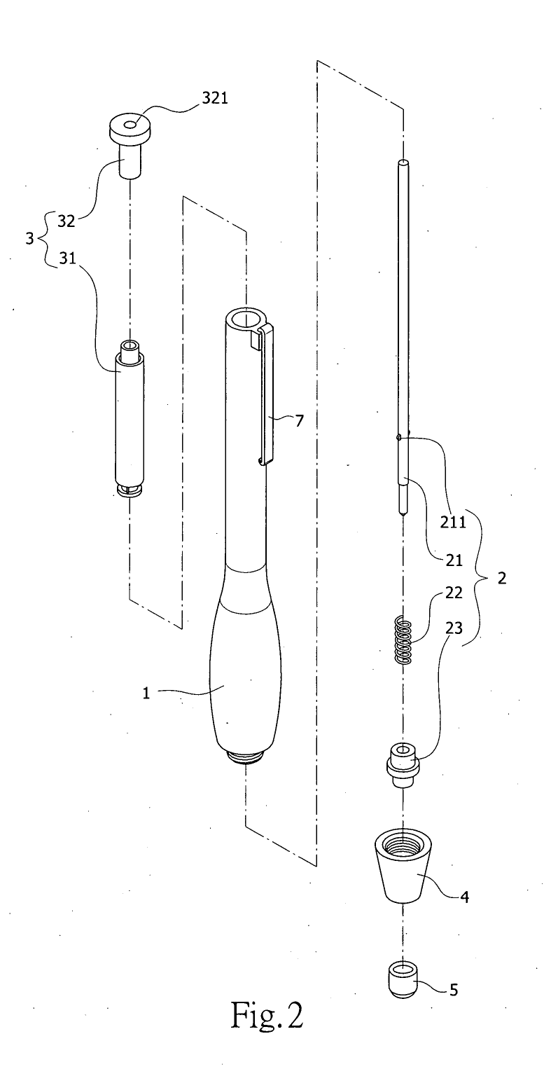

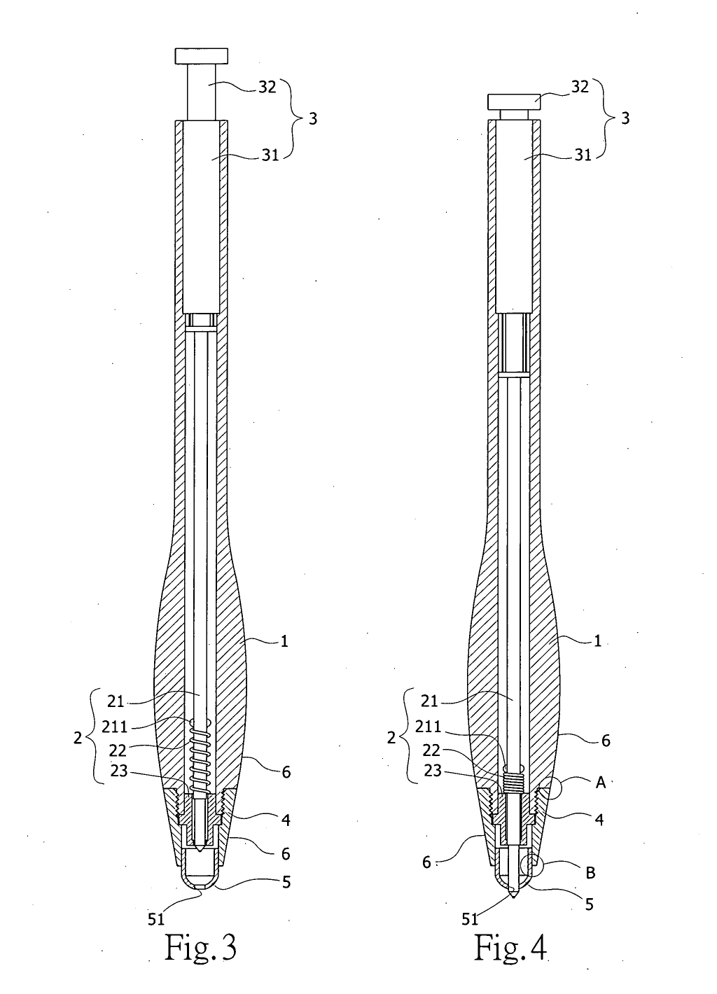

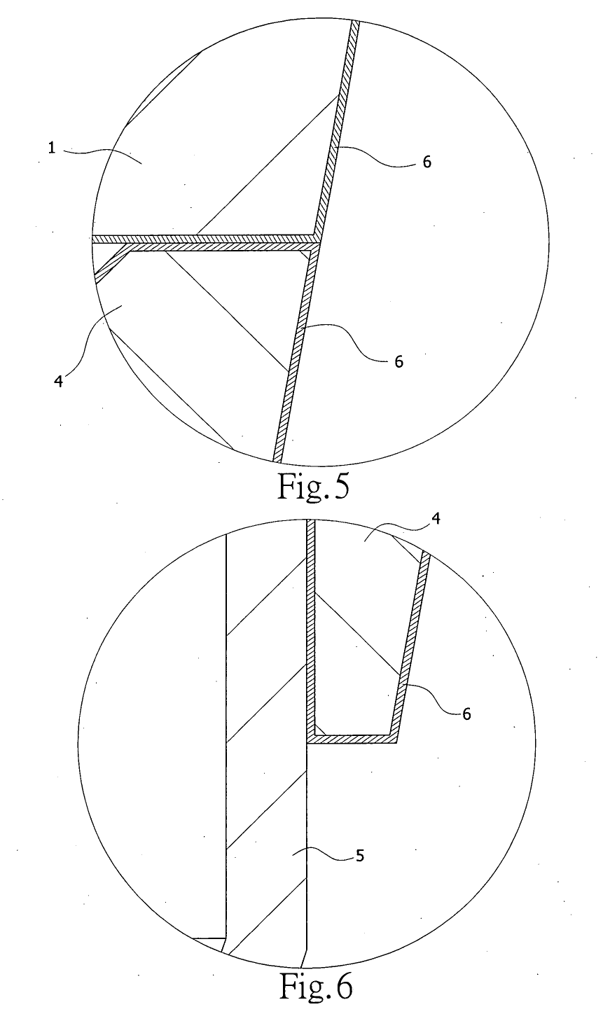

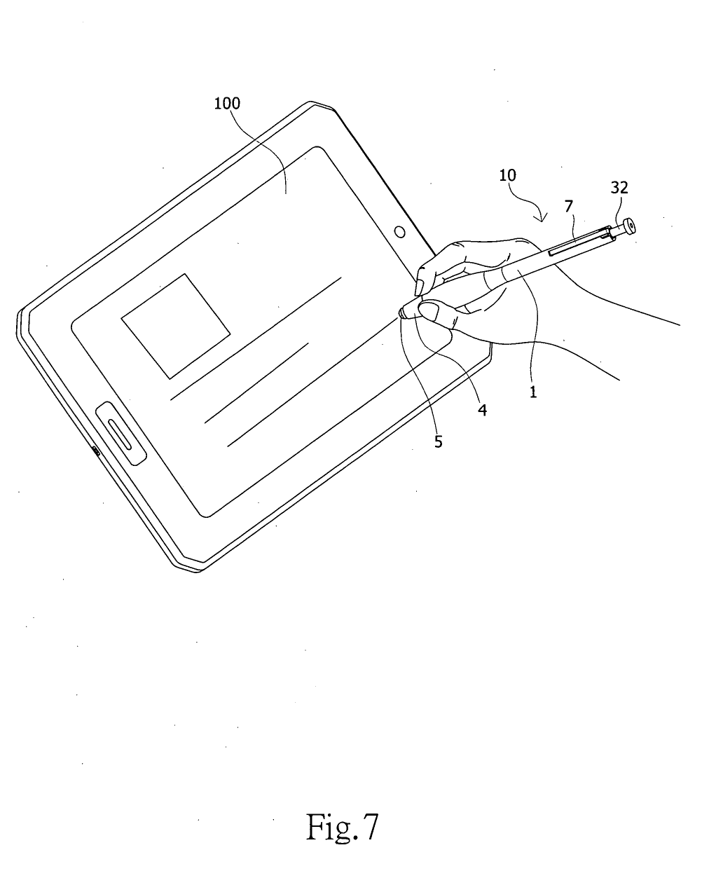

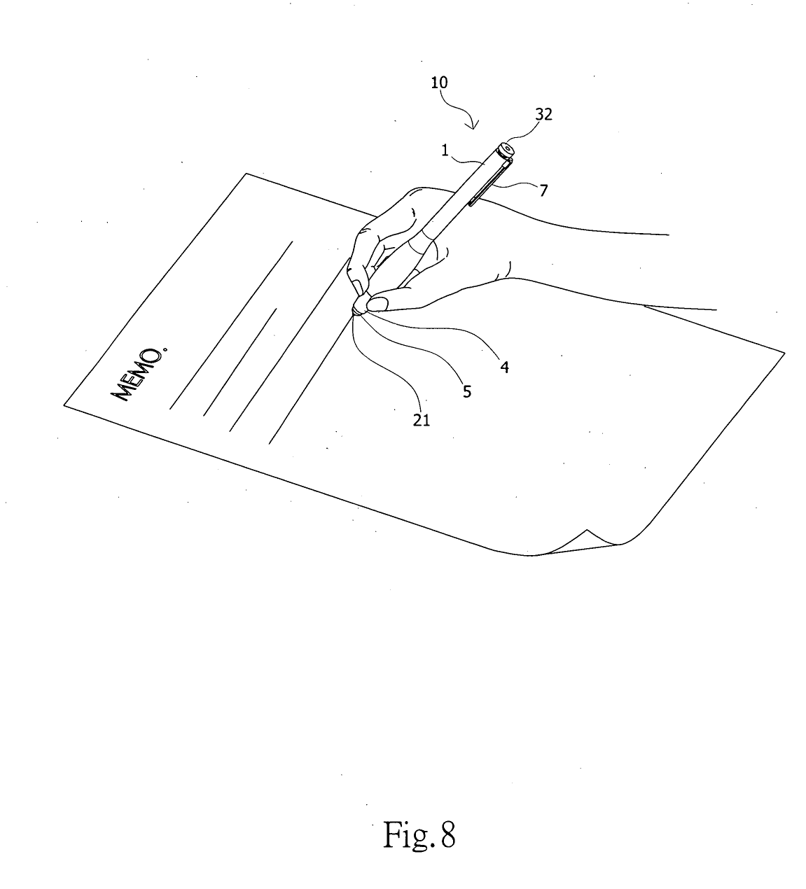

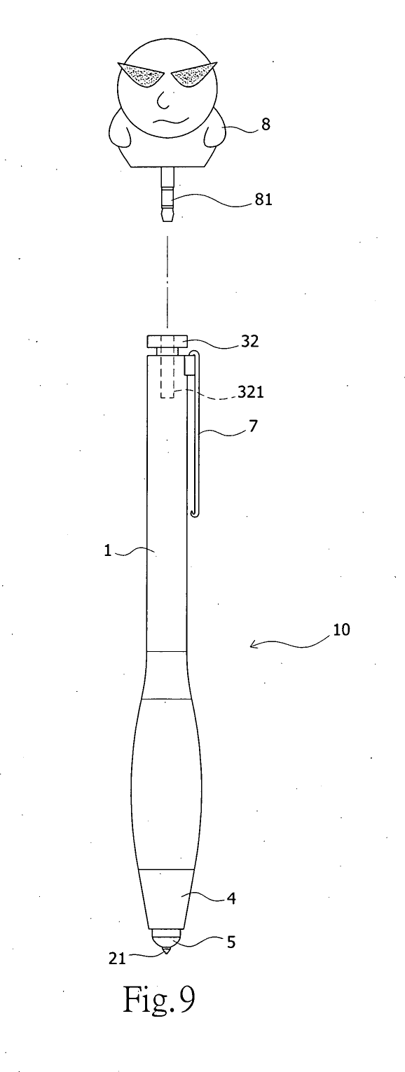

a stylus pen as shown in FIG. 1 to FIG. 9 is characterized in that: a stylus pen (10) comprises a barrel (1) which made of a non-mental material; an ink device (2) arranged inside the barrel (1); a thrust device (3) arranged at top of the barrel (1); a tip (4) disposed at the bottom of the barrel (1); and a touching head (5) disposed on the tip (4) and provided with an orifice (51) for the ink device (2) therethrough, both the non-metal barrel (1) and the tip (4) are coated with a layer of electroplate (6) in the surface for electric conduction so as to conduct the electric to a touch screen (100) of electronic product through the touching head (5) by transmission from an operator's static electric current. In this way, the stylus pen (10) is even lighter by non-mental material of barrel (1), said non-metal material can be used in PVC, PP, HDPE and PET. Therefore, it can lower the manufacturing costs.

Secondly, the user can use the stylus pen (10) to write on paper when the ink device (2) is pressed out from the orifice (51) of the touching head (5), and also can use it to slide on touch screen (100) of electronic product when the ink device (2) is pressed back to the barrel (1). In the way, the user can take the multifunction stylus pen (10) to facilitate bringing and using.

Said barrel (1) is further provided with a clip (7) arranged in the outside wall of the barrel (1). In this way, the stylus pen (10) can hold tightly in the pocket so as to facilitate collecting and bringing.

Said ink device (2) comprises an ink chamber (21) with two salient points (211); a spring (22) adjoined to the salient points (211) therebelow for the ink chamber (21) an upward resilient force; and a retaining piece (23) adjoined to the spring (22) therebelow. Furthermore, said thrust device (3) comprises a thrust tube (31) arranged inside the barrel (1) and connected with the top of the ink chamber (2); and a button (32) disposed at the top of the thrust tube (31). In this way, when pressing the button (32), the thrust tube (31) is pushed to the ink chamber (21) moving upward and downward inside the barrel (1) for the ink chamber (21) out or in the orifice (51) so as to facilitate changing for writing mode or touching mode.

Said button (32) is further provided with a doll (8) which has a plug (81) therebelow and an aperture (321) for the plug (81) inserted therein.

Wherein, the doll (8) can be plugged into the audio plug hole of electronic product for dustproof and waterproof. Besides, it increase certain entertaining and decorative effects.

Said touching head (5) is a conductive rubber. In this way, the capacitance value of the touch screen can be changed for generating circuit by the utility of the operator's static electric current through the barrel (1), the tip (4) and the touching head (5).

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood.

I claim:

1. A stylus pen is characterized in that:
a stylus pen (10) comprises a barrel (1) which made of a non-mental material;
an ink device (2) arranged inside the barrel (1);
a thrust device (3) arranged at top of the barrel (1);
a tip (4) disposed at the bottom of the barrel (1); and
a touching head (5) disposed on the tip (4) and provided with an orifice (51) for the ink device (2) therethrough,
both the non-mental barrel (1) and the tip (4) are coated with a layer of electroplate (6) in the surface for electric conduction so as to conduct the electric to a touch screen (100) of electronic product through the touching head (5) by transmission from an operator's static electric current.

2. A stylus pen according to claim 1 is characterized in that said barrel (1) is further provided with a clip (7) arranged in the outside wall of the barrel (1).

3. A stylus pen according to claim 1 is characterized in that said ink device (2) comprises an ink chamber (21) with two salient points (211);
a spring (22) adjoined to the salient points (211) therebelow for the ink chamber (21) an upward resilient force; and
a retaining piece (23) adjoined to the spring (22) therebelow.

4. A stylus pen according to claim 1 is characterized in that said thrust device (3) comprises a thrust tube (31) arranged inside the barrel (1) and connected with the top of the ink chamber (2); and a button (32) disposed at the top of the thrust tube (31).

5. A stylus pen according to claim 4 is characterized in that said button (32) is further provided with a doll (8) which has a plug (81) therebelow and an aperture (321) for the plug (81) inserted therein.

6. A stylus pen according to claim 1 is characterized in that said touching head (5) is a conductive rubber.
